(19) United States
(12) Patent Application Publication
(10) Pub. No.: US 2009/0297885 A1
(43) Pub. Date: Dec. 3, 2009

(54) Composite Comprising An Inorganic Substrate With A Coating Comprising Activated Carbon And Metal Sulfide

(76) Inventors: Kishor Purushottam Gadkaree, Big Flats, NY (US); Anbo Liu, Painted Post, NY (US); Joseph Frank Mach, Lindley, NY (US)

Correspondence Address: CORNING INCORPORATED, SP-TI-3-1, CORNING, NY, 14831, US

(21) Appl. No.: 12/129,907

(22) Filed: May 30, 2008

(51) Int. Cl. B05D 3/02; B32B 15/00

(52) U.S. Cl. 428/698; 427/372.2; 428/640

(57) ABSTRACT

A composite comprising an inorganic substrate with a coating comprising activated carbon and a metal sulfide. The composite may be used, for example, for the removal of a contaminant, such as mercury, from a fluid stream.

### FIELD OF THE DISCLOSURE

This disclosure relates to composites comprising an inorganic substrate with a coating comprising activated carbon and a metal sulfide. The composites may be used, for example, for the removal of a contaminant, such as mercury, from a fluid stream.

### BACKGROUND

Hazardous contaminant emissions have become environmental issues of increasing concern because of the dangers posed to human health. For instance, coal-fired power plants and medical waste incineration are major sources of human activity related mercury emission into the atmosphere.

It is estimated that there are 48 tons of mercury emitted from coal-fired power plants in the United States annually. One DOE-Energy Information Administration annual energy outlook projected that coal consumption for electricity generation will increase from 976 million tons in 2002 to 1,477 million tons in 2025 as the utilization of coal-fired generation capacity increases. However, mercury emission control regulations have not been rigorously enforced for coal-fired power plants. A major reason is a lack of effective control technologies available at a reasonable cost, especially for elemental mercury control.

A technology currently in use for controlling elemental mercury as well as oxidized mercury is activated carbon injection (ACI). The ACI process involves injecting activated carbon powder into a flue gas stream and using a fabric filter or electrostatic precipitator to collect the activated carbon powder that has sorbed mercury. ACI technologies generally require a high C:Hg ratio to achieve the desired mercury removal level (>90%), which results in a high portion cost for sorbent material. The high C:Hg ratio indicates that ACI does not utilize the mercury sorption capacity of carbon powder efficiently.

An activated carbon packed bed can reach high mercury removal levels with more effective utilization of sorbent material. However, a typical powder or pellet packed bed has a very high pressure drop, which significantly reduces energy efficiency. Further, these fixed beds are generally an interruptive technology because they require frequent replacement of the sorbent material depending on the sorption capacity.

Activated carbon honeycombs disclosed in US 2007/0261557 may be utilized to achieve high removal levels of contaminants such as toxic metals. The inventors have now discovered new materials for the removal of contaminants from fluids, which are described herein.

### DESCRIPTION OF EMBODIMENTS

One embodiment of the invention is a composite comprising:

an inorganic substrate; and

a coating on the inorganic substrate, wherein the coating comprises activated carbon and a metal sulfide.

Exemplary inorganic substrates include glass, glass-ceramic, ceramic, and metal substrates. Some example materials include cordierite, mullite, clay, magnesia, metal oxides, talc, zircon, zirconia, zirconates, zirconia-spinel, magnesium alumino-silicates, spinel, alumina, silica, silicates, borides, alumino-silicates, e.g., porcelains, lithium aluminosilicates, alumina silica, feldspar, titania, fused silica, nitrides, borides, carbides, e.g., silicon carbide, silicon nitride or combinations of these.

The substrates, which may be porous, may comprise one or more coatings of inorganic material, which may also be porous. Coatings of inorganic material may be provided as washcoats of inorganic material. Exemplary inorganic coating materials include cordierite, alumina (such as alpha-alumina and gamma-alumina), mullite, aluminum titinate, titania, zirconia, and ceria particles and combinations thereof.

The inorganic substrate may, for example, be in the form of a flow-through monolith, which may comprise one or more coatings of inorganic material as mentioned above. Exemplary flow-through monoliths include, for example, any monolithic structure comprising channels, porous networks, or any other passages that would permit the flow of a fluid stream through the monolith. For instance, the flow-through monolith may be a honeycomb monolith comprising an inlet end, an outlet end, and a multiplicity of cells extending from the inlet end to the outlet end, the cells being defined by intersecting porous cell walls. The honeycomb could optionally comprise one or more selectively plugged honeycomb cell ends to provide a wall flow-through structure that allows for more intimate contact between the fluid stream and cell walls. The composites of the invention may also have a flow-through structure that is described above.

The inorganic substrate and/or composite may alternatively be in the form of, for example, granules, pellets, or planar or tubular structures.

The inorganic substrate is coated with a coating that comprises activated carbon and metal sulfide. The coating may coat all or a portion of the surface of the inorganic substrate, and may impregnate the substrate to some extent if the surface of the substrate is porous. For instance, the coating may coat the inner channel surfaces of an inorganic honeycomb substrate and any outer surfaces of the honeycomb. In some embodiments, the activated carbon is in the form of an uninterrupted and continuous coating over all or a portion of the surface of the inorganic substrate, such as a honeycomb substrate.

The coating on the inorganic substrate comprises a metal sulfide. Exemplary metal sulfides include sulfides of manganese, copper, palladium, molybdenum, or tungsten. The metal element in the metal sulfide, however, is not limited to those examples. For instance, the metal element in the metal sulfides may be selected from alkali metals, alkaline earth metals, transition metals, rare earth metals (including lanthanoids), and other metals such as aluminum, gallium, indium, tin, lead, thallium and bismuth.

The coating may further comprise any other suitable materials in addition to the activated carbon and metal sulfide. For instance, the coating composition may comprise sulfur in addition to that present in the metal sulfide. The additional sulfur may include sulfur at any oxidation state, including elemental sulfur (0), sulfate (+6), and sulfite (+4), and including sulfur bound to the activated carbon. The term sulfur thus includes elemental sulfur or sulfur present in a chemical compound or moiety. Chemical compounds may include sulfur containing compounds such as organosilanes, such as mercaptoalkylsilanes.

The composites may be made by any suitable technique. In one embodiment, the composites may made by a method that comprises:

providing an inorganic substrate;

coating the substrate with a composition comprising:
a carbon precursor, and
a metal sulfide, or a combination of 1a) a metal oxide or salt or 1b) metal sulfide with 2) an additional sulfur source;

optionally curing the coating composition;

carbonizing the coating composition; and

activating the carbonized composition.

The substrate can be coated with the coating composition by any suitable technique, such as by dipping the substrate in the coating composition or spraying the coating composition on the substrate.

Carbon precursors include synthetic carbon-containing polymeric material, organic resins, charcoal powder, coal tar pitch, petroleum pitch, wood flour, cellulose and derivatives thereof, natural organic materials such as wheat flour, wood flour, corn flour, nut-shell flour, starch, coke, coal, or mixtures or combinations of any two or more of these.

In one embodiment, the coating composition comprises an organic resin as a carbon precursor. Exemplary organic resins include thermosetting resins and thermoplastic resins (e.g., polyvinylidene chloride, polyvinyl chloride, polyvinyl alcohol, and the like). Synthetic polymeric material may be used, such as phenolic resins or a furfural alcohol based resin such as furan resins. Exemplary suitable phenolic resins are resole resins such as plyophen resins. An exemplary suitable furan liquid resin is Furcab-LP from QO Chemicals Inc., IN, U.S.A. An exemplary solid resin is solid phenolic resin or novolak.

The metal sulfide may be any metal sulfide discussed above. In embodiments where a metal salt or metal oxide is provided in the mixture with an additional sulfur source, the two may react to form a metal sulfide during the forming of the composite. Exemplary metals in the metal salts or oxides include any metals mentioned above that may form the metal sulfides. The metal sulfide, metal salt or metal oxide may be provided in the coating composition in any appropriate form. For instance, the metal sulfide or metal oxide may be present as insoluble particles or powder in the carbon precursor, and the metal salt may be soluble within the carbon precursor, such as within an organic resin. The coating composition may also include metal sulfides together with metal oxides or metal salts.

The additional sulfur source may be any source of sulfur in elemental or oxidized state. This includes sulfur powder, sulfur-containing powdered resin, sulfides, sulfates, and other sulfur-containing compounds, and mixtures or combination of any two or more of these. Exemplary sulfur-containing compounds include hydrogen sulfide and/or its salts, carbon disulfide, sulfur dioxide, thiophene, sulfur anhydride, sulfur halides, sulfuric ester, sulfurous acid, sulfacid, sulfatol, sulfamic acid, sulfan, sulfanes, sulfuric acid and its salts, sulfite, sulfoacid, sulfobenzide, sulfur containing organosilanes and mixtures thereof.

The coating compositions may optionally also include inorganic and/or (carbonizable or non-carbonizable) organic fillers and/or binders. Inorganic fillers can include oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, mullite, cordierite, silica, alumina, other oxide glass, other oxide ceramics, or other refractory material.

Exemplary organic binders include cellulose compounds. Cellulose compounds include cellulose ethers, such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. An example methylcellulose binder is METHOCEL A, sold by the Dow Chemical Company. Example hydroxypropyl methylcellulose binders include METHOCEL E, F, J, K, also sold by the Dow Chemical Company. Binders in the METHCEL 310 Series, also sold by the Dow Chemical Company, can also be used in the context of the invention. METHOCEL A4M is an example binder for use with a RAM extruder. METHOCEL F240C is an example binder for use with a twin screw extruder.

The coating composition may also optionally comprise forming aids. Exemplary forming aids include soaps, fatty acids, such as oleic, linoleic acid, sodium stearate, etc., polyoxyethylene stearate, etc. and combinations thereof. Other additives that can be useful for improving the extrusion and curing characteristics of the batch are phosphoric acid and oil. Exemplary oils include petroleum oils with molecular weights from about 250 to 1000, containing paraffinic and/or aromatic and/or alicyclic compounds. Some useful oils are 3 in 1 oil from 3M Co., or 3 in 1 household oil from Reckitt and Coleman Inc., Wayne, N.J. Other useful oils can include synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soyabean oil etc. are also useful.

The coating composition, such as one comprising a curable organic resin, may optionally be cured under any appropriate conditions. Curing can be performed, for example, in air at atmospheric pressures and typically by heating the coating at a temperature of from 70° C. to 200° C. for about 0.5 to about 5.0 hours. In certain embodiments, the coating is heated from a low temperature to a higher temperature in stages, for example, from 70° C., to 90° C., to 125° C., to 150° C., each temperature being held for a period of time. Additionally, curing can also be accomplished by adding a curing additive such as an acid additive at room temperature.

The coating composition can then be subjected to a carbonization step. For instance, the coating composition may be carbonized by subjecting it to an elevated carbonizing temperature in an O₂-depleted atmosphere. The carbonization temperature can range from 600 to 1200° C., in certain embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the batch mixture body decompose to leave a carbonaceous residue.

The carbonized coating composition may then be activated. The carbonized batch mixture body may be activated, for example, in a gaseous atmosphere selected from CO₂, H₂O, a mixture of CO₂ and H₂O, a mixture of CO₂ and nitrogen, a mixture of H₂O and nitrogen, and a mixture of CO₂ and another inert gas, for example, at an elevated activating temperature in a CO₂ and/or H₂O-containing atmosphere. The atmosphere may be essentially pure CO₂ or H₂O (steam), a mixture of CO₂ and H₂O, or a combination of CO₂ and/or H₂O with an inert gas such as nitrogen and/or argon. Utilizing a combination of nitrogen and CO₂, for example, may result in cost savings. A CO₂ and nitrogen mixture may be used, for example, with CO₂ content as low as 2% or more. Typically a mixture of CO₂ and nitrogen with a CO₂ content of 5-50% may be used to reduce process costs. The activating temperature can range from 600° C. to 1000° C., in certain embodiments from 600° C. to 900° C. During this step, part of the carbonaceous structure of the carbonized batch mixture body is mildly oxidized:

CO₂(g)+C(s)→2CO(g),

H₂O(g)+C(s)→H₂(g)+CO(g),

resulting in the etching of the structure of the carbonaceous body and formation of an activated carbon matrix that can define a plurality of pores on a nanoscale and microscale. The activating conditions (time, temperature and atmosphere) can be adjusted to produce the final product with the desired specific area.

As an alternative to the method discussed above, an activated carbon coating may be formed on the inorganic substrate, then impregnated with a metal sulfide. For example, the inorganic substrate coated with activated carbon may be contacted and impregnated with a solution comprising a metal sulfide, such as by dipping the inorganic substrate in the solution or spraying it with the solution.

The composites of the invention may be used, for example, for the sorption of any contaminant from a fluid through contact with the fluid. For example, a fluid stream may be passed through a flow-through composite such as a honeycomb shaped composite described above. The fluid stream may be in the form of a gas or a liquid. The gas or liquid may also contain another phase, such as a solid particulate in either a gas or liquid stream, or droplets of liquid in a gas stream. Example gas streams include coal combustion flue gases (such as from bituminous and sub-bituminous coal types or lignite coal) and syngas streams produced in a coal gasification process.

The terms “sorb,” “sorption,” and “sorbed,” refer to the adsorption, absorption, or other entrapment of the contaminant on the sorbent, either physically, chemically, or both physically and chemically.

Contaminants to be sorbed include, for instance, contaminants at 3 wt % or less within the fluid stream, for example at 2 wt % or less, or 1 wt % or less. Contaminants may also include, for instance, contaminants at 10,000 μg/m³ or less within the fluid stream. Example contaminants include metals, including toxic metals. The term “metal” and any reference to a particular metal or other contaminant by name herein includes the elemental forms as well as oxidation states of the metal or other contaminant. Sorption of a metal or other named contaminant thus includes sorption of the elemental form of the metal or other contaminant as well as sorption of any organic or inorganic compound or composition comprising the metal or other contaminant.

Example metals that can be sorbed include cadmium, mercury, chromium, lead, barium, beryllium, and chemical compounds or compositions comprising those elements. In one embodiment, the metal is mercury in an elemental (Hg°) or oxidized state (Hg⁺ or Hg²⁺). Example forms of oxidized mercury include HgO and halogenated mercury, for example Hg₂Cl₂ and HgCl₂. Other exemplary metallic contaminants include nickel, cobalt, vanadium, zinc, copper, manganese, antimony, silver, and thallium, as well as organic or inorganic compounds or compositions comprising them. Additional contaminants include arsenic and selenium as elements and in any oxidation states, including organic or inorganic compounds or compositions comprising arsenic or selenium.

The contaminant may be in any phase that can be sorbed on the composite. Thus, the contaminant may be present, for example, as a liquid in a gas fluid steam, or as a liquid in a liquid fluid stream. The contaminant could alternatively be present as a gas phase contaminant in a gas or liquid fluid stream. In one embodiment, the contaminant is mercury vapor in a coal combustion flue gas or syngas stream.

It should be understood that while the invention has been described in detail with respect to certain illustrative embodiments thereof, it should not be considered limited to such, as numerous modifications are possible without departing from the broad spirit and scope of the invention as defined in the appended claims.

We claim:

1. A composite comprising:
an inorganic substrate; and
a coating on the inorganic substrate, wherein the coating comprises activated carbon and a metal sulfide.

2. A composite according to claim 1, wherein the inorganic substrate is a glass, glass-ceramic, ceramic, or metal substrate.

3. A composite according to claim 1, wherein the inorganic substrate is a substrate comprising one or more coatings of inorganic material.

4. A composite according to claim 3, wherein the inorganic substrate is a substrate comprising a washcoat of inorganic material.

5. A composite according to claim 4, wherein the inorganic material is gamma-alumina.

6. A composite according to claim 1, wherein the composite is in the form of a flow-through structure.

7. A composite according to claim 6, wherein the flow-through structure is a honeycomb structure.

8. A composite according to claim 1, wherein the metal sulfide is a sulfide of manganese, copper, palladium, molybdenum, or tungsten.

9. A composite according to claim 1, wherein the coating further comprises sulfur in addition to that present in the metal sulfide.

10. A composite according to claim 9, wherein the coating comprises elemental sulfur.

11. A method for making a composite according to claim 1, which comprises:
providing an inorganic substrate;
coating the substrate with a composition comprising:
a carbon precursor, and
a metal sulfide, or a combination of 1a) a metal oxide or salt or 1b) metal sulfide with 2) an additional sulfur source;
optionally curing the coating composition;
carbonizing the coating composition; and
activating the carbonized composition.

12. A method according to claim 11, wherein the organic resin is a phenolic resin.

13. A method according to claim 11, wherein the metal sulfide, metal oxide, or metal salt is a sulfide, oxide, or salt of manganese, copper, palladium, molybdenum, or tungsten.

14. A method according to claim 11, wherein the coating composition comprises particles or powder of metal sulfide or metal oxide.

15. A method according to claim 11, wherein the coating composition comprises a metal salt soluble in an organic resin.

16. A method according to claim 11, wherein the coating composition comprises elemental sulfur as the additional sulfur source.

17. A method according to claim 11, wherein the inorganic substrate is a glass, glass-ceramic, ceramic, or metal substrate.

18. A method according to claim 11, wherein the inorganic substrate is a flow-through monolith.

19. A method according to claim 18, wherein the inorganic substrate is a honeycomb monolith.
